(19) United States
(12) Patent Application Publication
(10) Pub. No.: US 2005/0195559 A1
(43) Pub. Date: Sep. 8, 2005

(54) Screen-pivoting structure

(75) Inventor: Ying-Ta Lu, Taipei (TW)

Correspondence Address: TROXELL LAW OFFICE PLLC, SUITE 1404, 5205 LEESBURG PIKE, FALLS CHURCH, VA, 22041, US

(73) Assignee: FIRST INTERNATIONAL COMPUTER INC.

(21) Appl. No.: 10/792,843

(22) Filed: Mar. 5, 2004

(51) Int. Cl. G06F 1/16

(52) U.S. Cl. 361/681; 361/682; 248/918

(57) ABSTRACT

A screen-pivoting structure is adopted for an electronic product with a base. The screen-pivoting structure has a pivoting unit arranged on an edge of the base of the electronic product, a frame unit having a bottom edge disposed on the pivoting unit along a horizontal direction, and a display with two opposite sides pivoting on the frame unit about a common predetermined axle of the frame unit. The display rotates about the common predetermined axle, the screen-pivoting structure can be module-manufactured, and the display is replaceable without changing the frame unit for meeting size requirements thereby.

### BACKGROUND OF THE INVENTION

1. Field of the Invention

The present invention relates to a screen-pivoting structure, and particularly relates to a screen-pivoting structure adopted for an electronic product.

2. Background of the Invention

Referring to FIG. 1, a first conventional notebook 1a includes a base 10a, a cover 11, a LCD monitor (Liquid Crystal Display monitor) 12a arranged on the cover 11, and an axle 13a connecting the base 10a and the cover 11a. The cover 11a is connected to the base 10a by the axle 13a and horizontally pivots thereon by means of axle 13a. The axle 13a may be disposed on one edge of the base 10a and the cover 11a and extends laterally, and an opposite edge of the base 10a and the cover 11a includes a sleeve portion allowing the axle 13a to penetrate therein. The cover 11a rotates around the axle 13a to open or close the first conventional notebook 1a.

The first conventional notebook 1a fails to provide the LCD monitor 12a to turn back in satisfaction of particular requirements. A notebook, nowadays, sometimes has a screen that can flip and be turned back, and the first conventional notebook 11a obviously cannot achieve this kind of object.

With reference to FIGS. 2 and 2A, a second conventional notebook 2a, which provides solutions to problems mentioned above, includes a base 20a, a first axle 23a vertically pivoting on the base 20a, a cover 21a arranged above the base 20a via a second axle 24a horizontally pivoting on the first axle 23a, and a LCD monitor 22a arranged on the cover 21a. The base 20a has a pivot hole in an edge thereof, in which the first axle 23a vertically pivots. The first axle 23a has a horizontal through hole. The cover 21a has a recess for receiving the first axle 23a and the second axle 24 therein. The second axle 24a penetrates through the through hole of the first axle 23a. Therefore, the cover 21a rotates around the first axle 23a for opening or closing the first conventional notebook 1a and rotates about the second axle 24a for turning the cover 21a back thereby.

However, the second notebook 2a needs new designs for elements thereof, such as, for example, the pivoting hole of the base 20a and structures corresponding to the pivoting hole thereof and the first and the second axles 23a, 24a. The base 2a needs to be remolded, and the assembly steps should be accordingly revised. Simultaneously, due to the burden on first axle 23a, including the collective weight of the LCD monitor 22a, the cover 21a and the second axle 24a as well as the function of rotation, the first axle 23a needs high-precision design for high reliability in both support and rotation Accordingly, the costs can't be reduced and may even increase.

Hence, an improvement over the prior art is required to overcome the disadvantages thereof.

### SUMMARY OF INVENTION

The primary object of the invention is therefore to specify a screen-pivoting structure, which can flip or turn back a display thereof, for reducing costs and extra designs.

The secondary object of the invention is therefore to specify a screen-pivoting structure, which can be changed easily for meeting requirements.

The third object of the invention is therefore to specify a screen-pivoting structure, which can be module-manufactured to simplify steps and reduce costs further.

According to the invention, this object is achieved by a screen-pivoting structure adopted for an electronic product with a base, the screen-pivoting structure includes a pivoting unit arranged an edge of the base of the electronic product, a frame unit having a bottom edge disposed on the pivoting unit along a horizontal direction, and a display including two opposite sides pivoting on the frame unit about a common predetermined axle of the frame unit. The display rotates about the common predetermined axle, the screen-pivoting structure can be module-manufactured, and the display is replaceable without changing the frame unit to meet size requirements.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

These and other features, aspects, and advantages of the present invention will become better understood with regard to the following description, appended claims, and accompanying drawings where:

FIG. 1 is a perspective view of a first conventional notebook;

FIG. 2 is a perspective view of a second conventional notebook;

FIG. 2A is an enlarged view of the second conventional notebook;

FIG. 3 is a perspective view of a screen-pivoting structure according to the present invention;

FIG. 4 is a cross-sectional profile of the screen-pivoting structure according to a first embodiment of the present invention;

FIG. 5 is a cross-sectional profile of the screen-pivoting structure according to a second embodiment of the present invention;

FIG. 6 is a perspective view of the screen-pivoting structure according to a third embodiment of the present invention; and

FIG. 7 is a perspective view of the screen-pivoting structure according to a third embodiment of the present invention.

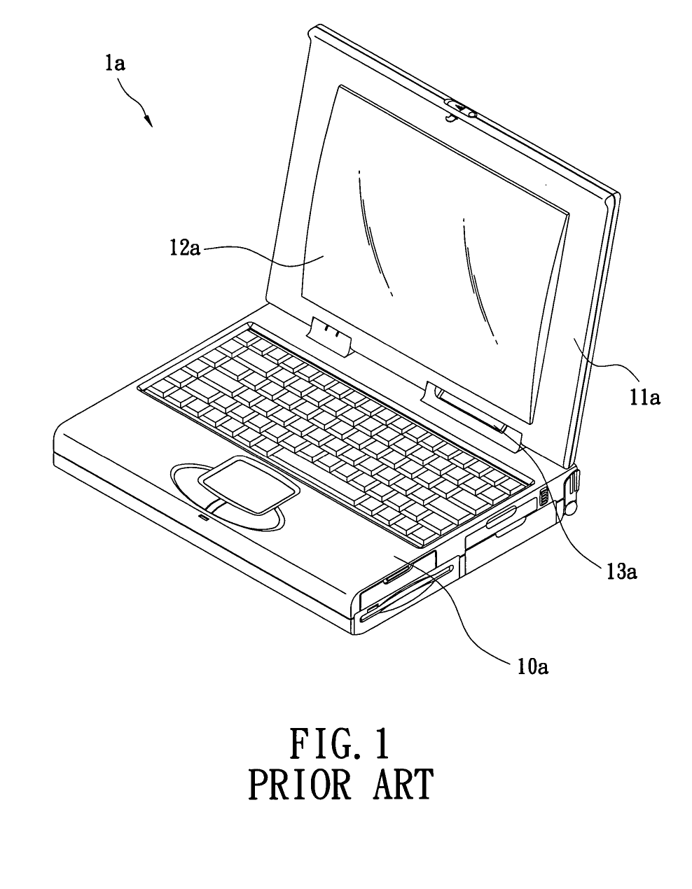

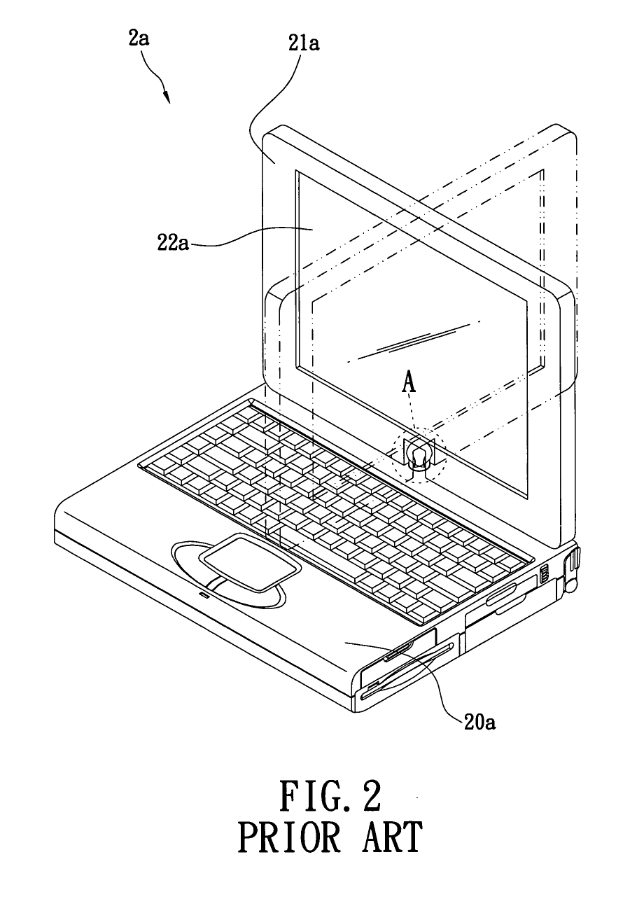

### DETAILED DESCRIPTION OF THE EMBODIMENTS

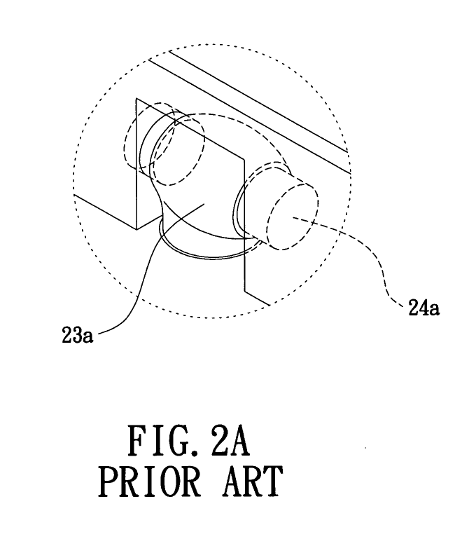

FIG. 3 is an illustration of a screen-pivoting structure adopted for an electronic product 3 according to the present invention. The electronic product 3 includes a base 30. The screen-pivoting structure includes a pivoting unit 33 arranged an edge of the base 30 of the electronic product, a frame unit 31 having a bottom edge disposed on the pivoting unit 33 along a horizontal direction, and a display 32 pivoting on the frame unit 31. The display 32 rotates about the common predetermined axle, and the display can be replaceable without changing the frame unit to meet size requirements. The frame unit 31 connects to the base 30 as illustrated for the first conventional notebook 1a; for example, the frame unit 31 or the base 30 has an axle protruding laterally and pivoting the frame 31 to the base 30, and the base 30 or the frame unit 31 has a corresponding sleeve portion receiving the axle. The frame unit 31 rotates about the pivoting unit 33 for opening or closing the electronic product 3. Accordingly, the base 30 can be applied in the manner mentioned above, and needs no additional design or costs. Additionally, the pivoting unit 33 is an original design, and prevents the problems suffered by the second conventional notebook 2a, which is more expensive and complex to manufacture due to the high reliability of the first axle 23a.

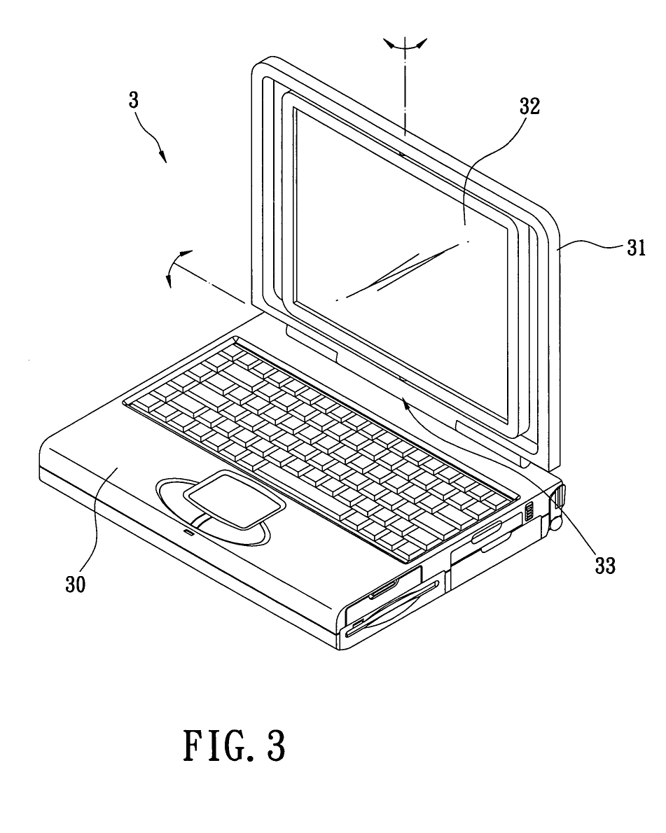

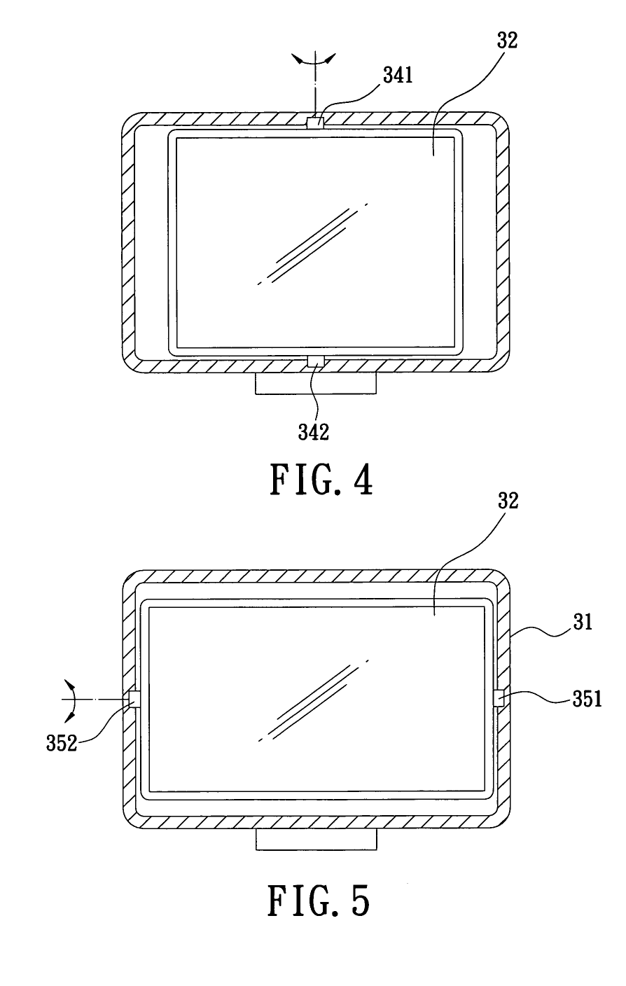

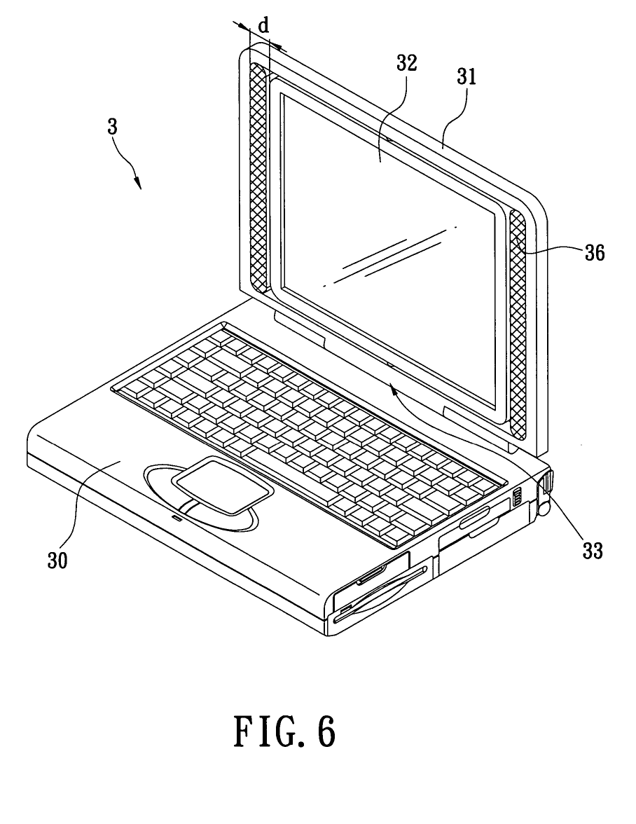

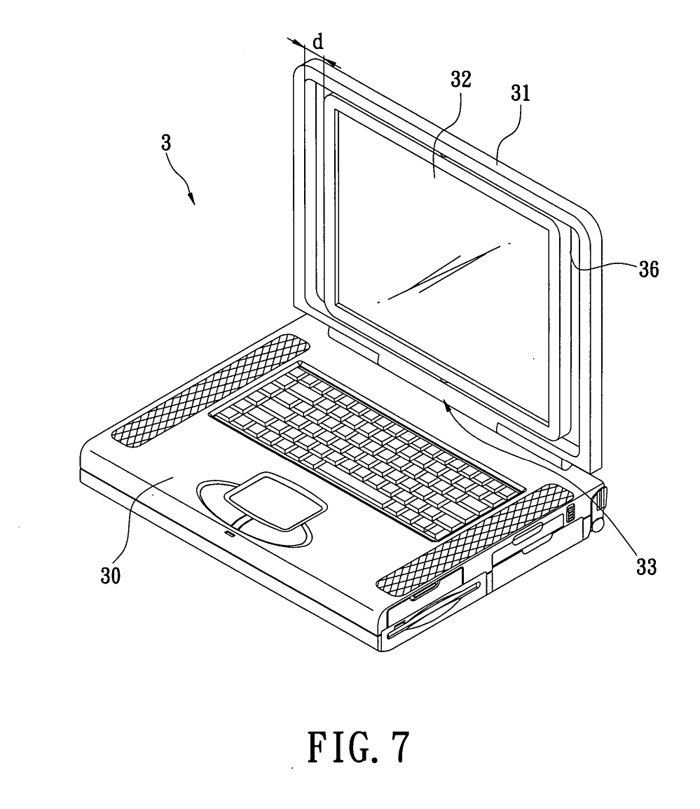

the display 32 includes two opposite sides pivoting on the frame unit 31 about a common predetermined axle of the frame unit 31. The common predetermined axle can be vertical or horizontal, and the display 32 can rotate or turn back via the common predetermined axle in a vertical direction or a horizontal direction. As illustrated in FIGS. 4 and 5, the connection between display 32 and the frame unit 31 can be provided in several ways. The two opposite sides of the display 32 are respectively upper and lower sides thereof, and the display 32 can include an upper pivoting axle and a lower pivoting axle 341, 342 respectively and vertically arranged on the two opposite sides thereof. The frame unit 31 can have two opposite holes recessed on upper and lower sides thereof for receiving the upper and the lower pivoting axles 341, 342 respectively. Conversely, the upper and the lower pivoting axles 341, 342 are respectively disposed on the frame unit 31, and the display 32 has two corresponding upper and lower holes formed therein for receiving the upper and the lower pivoting axles 341, 342. Alternately, the two opposite sides of the display 32 are respectively two lateral sides thereof, and the display 32 includes a right pivoting axle and a left pivoting axle 351, 352 respectively and horizontally arranged on the two opposite sides thereof, and the frame unit 31 has two opposite holes recessed in two lateral sides thereof for receiving the right and the left pivoting axles 351, 352 respectively. Conversely, the right and the left pivoting axles 351, 352 are respectively disposed on the frame unit 31, and the display 32 has two corresponding upper and lower holes formed therein for receiving the right and the left pivoting axles 351, 352.

The screen-pivoting structure can be module-manufactured to allow the display 32 to have an aspect ratio of 4 to 3 or 16 to 9. The display 32 can be exchanged without the changing the frame unit 31 to save costs and manufacturing steps.

According to different aspect ratios of the display 32, the display 32 cannot have sizes completely equivalent to the frame unit 31; the display 32 has a width equal to or less than that of the frame unit 31. Therefore, the screen-pivoting structure includes two predetermined gaps d formed at lateral sides thereof and respectively between the frame unit 31 and the display 32, and the electronic product 3 includes two amplifiers 36 combined with the base 30 thereof and respectively corresponding to the two predetermined gaps d at lateral sides thereof. The two amplifiers 36 are exposed by the two gaps d, respectively, when the electronic product 3 is closed. Conversely, the electronic product 3 includes two amplifiers 36 combined with the frame unit 31 and respectively corresponding to the two predetermined gaps d at lateral sides thereof.

In conclusion, the present invention provides the screen-pivoting structure adopted for the electronic product 3; the base 30 of the electronic product 3 horizontally pivots on the frame unit 31 via the pivoting unit 33. The display 32 can rotate about the pivoting unit 33 to close the electronic product 3. In addition, the display 32 can be rotated or turned back about the common predetermined axle thereof. The screen-pivoting structure can be module-manufactured for different aspect ratios. Therefore, the screen-pivoting structure can decrease extra designs, costs and steps.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

1. A screen-pivoting structure adopted for an electronic product including a base, the screen-pivoting structure comprising:
a pivoting unit arranged on an edge of the base of the electronic product;
a frame unit having a bottom edge disposed on the pivoting unit in a horizontal direction; and
a display including two opposite sides pivoted to the frame unit about a common predetermined axle of the frame unit;
whereby the display rotates about the common predetermined axle and the display is replaceable for meeting size requirements.

2. The screen-pivoting structure as claimed in claim 1, wherein the common predetermined axle is vertical or horizontal.

3. The screen-pivoting structure as claimed in claim 1, wherein the two opposite sides of the display are respectively upper and lower sides thereof, and the display includes an upper pivoting axle and a lower pivoting axle respectively and vertically arranged on the two opposite sides thereof, the frame unit has two opposite holes in upper and lower sides thereof for receiving the upper and the lower pivoting axles, respectively, or the two opposite sides of the display are respectively two lateral sides thereof, and the display includes a right pivoting axle and a left pivoting axle respectively and horizontally arranged on the two opposite sides thereof, and the frame unit has two opposite holes in two lateral sides thereof for receiving the right and the left pivoting axles, respectively.

4. The screen-pivoting structure as claimed in claim 1, wherein the display has a width less than that of the frame unit, the screen-pivoting structure thus includes two predetermined gaps formed at lateral sides thereof and respectively between the frame unit and the display, and the electronic product includes two amplifiers combined with the base thereof and respectively corresponding to the two predetermined gaps at lateral sides thereof.

5. The screen-pivoting structure as claimed in claim 1, wherein the display has a width less than that of the frame unit, the screen-pivoting structure thus includes two predetermined gaps formed at lateral sides thereof and respectively between the frame unit and the display, and the electronic product includes two amplifiers combined with the frame unit and respectively corresponding to the two predetermined gaps at lateral sides thereof.

6. The screen-pivoting structure as claimed in claim 1, wherein the display has an aspect ratio of about 4 to 3.

7. The screen-pivoting structure as claimed in claim 1, wherein the display has an aspect ratio of about 16 to 9.
